(19) United States
(12) Patent Application Publication
(10) Pub. No.: US 2020/0071798 A1
(43) Pub. Date: Mar. 5, 2020

(54) STEEL FOR PRESSURE VESSELS WITH EXCELLENT RESISTANCE TO HIGH-TEMPERATURE TEMPERING HEAT TREATMENT AND POST-WELD HEAT TREATMENT AND MANUFACTURING METHOD THEREFOR

(71) Applicant: POSCO, Pohang-si, Gyeongsangbuk-do (KR)

(72) Inventor: Soon-Taik Hong, Pohang-si, Gyeongsangbuk-do (KR)

(21) Appl. No.: 16/466,462

(22) PCT Filed: Dec. 7, 2017
(86) PCT No.: PCT/KR2017/014285

§ 371 Date: Jun. 4, 2019

(30) Foreign Application Priority Data
Dec. 20, 2016 (KR) 10-2016-0174585

(51) Int. Cl. C22C 38/04; C22C 38/02; C22C 38/44; C21D 8/02; C21D 9/00; C21D 9/46

(52) U.S. Cl. CPC C22C 38/04; C22C 38/02; C22C 38/44; F17C 1/00; C21D 9/0081; C21D 9/46; C21D 8/0205; C21D 8/0226

(57) ABSTRACT

The present invention relates to steel for pressure vessels used in a boiler, a pressure vessel fittings, etc. of a power station and, more particularly, to steel for pressure vessels with excellent resistance to high-temperature tempering heat treatment and post-weld heat treatment; and a manufacturing method therefor.

### TECHNICAL FIELD

The present disclosure relates to steel for pressure vessels used in a boiler, a pressure vessel, fittings, and the like, of a power station, and more particularly, to steel for pressure vessels with excellent resistance to a high-temperature tempering heat treatment and a post-weld heat treatment, and a manufacturing method therefor.

### BACKGROUND ART

According to a recent trend for oilfields in poor surroundings to be actively developed, due to the era of high oil prices as well as petroleum in being in recent short supply, the thickness of steel vessels for refining and storing crude oil has been increased.

A Post Weld Heat Treatment (PWHT) is carried out to eliminate stress generated during welding for the purpose of preventing the deformation of a structure after welding and stabilizing a shape and a size if the steel is welded in addition to the thickening of steel.

However, a steel sheet passing through the PWHT process for a lengthy period of time may have a problem in which tensile strength of the steel sheet may be deteriorated due to coarsening of the structure of the steel sheet. Also, a lengthy PWHT process may cause a phenomenon in which strength and toughness of the steel sheet are lowered at the same time due to softening of matrix structures and crystal grain boundaries, growth of crystal grains, coarsening of carbides, and others.

Reference 1 uses a method of applying a tempering heat treatment to a thickened steel material of which contents of C, Si, Mn, Cr, Mo, Ni, Cu, Sol.Al, P, and S are controlled, that is, performing a low temperature heat treatment after a high temperature heat treatment to compensate for a reduction in strength caused by a decrease of dislocation density during a high temperature tempering process through a precipitation strengthening effect generated in a low tempering process. However, even when the above-described method is applied, resistance may significantly degrade due to a PWHT process.

Meanwhile, the above-described thick steel material may have a problem in which strength and toughness of the material may significantly degrade during a fitting process performed in a middle and high temperature environment.

Thus, it may be required to develop steel which may be appropriately used in a middle and high temperature environment while significantly reducing degradation of strength and toughness after a lengthy PWHT process.

(Reference 1) Korean Laid-Open Patent Publication No.

2012-0073448

### DISCLOSURE

### Technical Problem

An aspect of the present disclosure is to provide steel for pressure vessels with excellent resistance to high-temperature tempering heat treatment and post-weld heat treatment, which may be appropriately used at middle and higher temperature of about 350 to 600° C., and degradation of strength and toughness of which is significantly reduced after a lengthy PWHT process, and a manufacturing method therefor.

### Technical Solution

According to an aspect of the present disclosure, steel for pressure vessels with excellent resistance with respect to a high-temperature tempering heat treatment and a post-weld heat treatment is provided, the steel for pressure vessels comprising: by wt %, 0.05 to 0.17% of C, 0.50 to 1.00% of Si, 0.3 to 0.8% of Mn, 1.0 to 1.5% of Cr, 0.3 to 1.0% of Mo, 0.003 to 0.30% of Ni, 0.003 to 0.30% of Cu, 0.005 to 0.06% of Sol.Al, 0.015% or less of P, 0.020% or less of S, two or more selected from a group consisting of 0.002 to 0.025% of Nb, 0.002 to 0.03% of V, and 0.002 to 0.15% of Co, and the balance of Fe and inevitable impurities, and the steel comprises a mixture structure of tempered martensite and bainite as a microstructure, and an area fraction of tempered martensite is 20% or higher.

According to another aspect of the present disclosure, a method of manufacturing steel for pressure vessels is provided, the method, comprising: reheating a steel slab satisfying the above-described alloy composition at 1000 to 1250° C., manufacturing a hot-rolled steel sheet by hot-rolling the reheated steel slab; performing a heat treatment in which the hot-rolled steel sheet is maintained at 850 to 950° C. for 1.3×t+10 to 30 minutes, where t indicates a thickness of the steel sheet in mm units; cooling the hot-rolled steel sheet on which the heat treatment is performed at a cooling speed of 2˜30° C./s; and performing a tempering treatment process in which the cooled hot-rolled steel sheet at 600 to 750° C. for 1.6×t+10 to 30 minutes, where t indicates a thickness of the steel sheet in mm units, and the tempering treatment is performed after the heat treatment and the cooling are further performed twice.

### Advantageous Effects

According to the present disclosure, steel for pressure vessels of which strength and toughness may not degrade after a lengthy PWHT process, performed for a maximum of 50 hours, may be provided.

### BEST MODE FOR INVENTION

The inventors have researched on a method for improving resistance against degradation of strength and toughness of steel for pressure vessels used at the middle and high temperature of about 350 to 600° C. in the industry of a power plant, a plant, and the like, after a post-weld heat treatment (PWHT) performed to reduce residual stress generated during welding the steel. As a result, it has been found that, by optimizing an alloy composition and manufacturing conditions of the steel for pressure vessels, steel having excellent resistance with respect to a high-temperature tempering heat treatment and a post-weld heat treatment may be provided.

When manufacturing steel for pressure vessels having target properties in the present disclosure, by performing a normalizing heat treatment process three times, excellent resistance against degradation of strength and toughness may be secured even after a lengthy PWHT process.

Hereinafter, the present disclosure will be described in greater detail.

Steel for pressure vessels with excellent resistance with respect to a high-temperature tempering heat treatment and a post-weld heat treatment according to an example embodiment may include 0.05 to 0.17% of C, 0.50 to 1.00% of Si, 0.3 to 0.8% of Mn, 1.0 to 1.5% of Cr, 0.3 to 1.0% of Mo, 0.003 to 0.30% of Ni, 0.003 to 0.30% of Cu, 0.005 to 0.06% of Sol.Al, 0.015% or less of P, 0.020% or less of S by wt %.

In the description below, the alloy composition of steel for pressure vessels controlled as above will be described in greater detail. A content of each component may be represented by wt % unless otherwise indicated.

C: 0.05 to 0.17%

Carbon (C) is an element which may be effective for improving strength of steel. When a content of C is less than 0.05%, strength of a matrix structure may degrade. When a content of C exceeds 0.17%, strength may excessively increase, which may degrade toughness.

Thus, it may be preferable to control a content of C to be 0.05 to 0.17%. A more preferable content of C may be 0.08 to 0.15%.

Si: 0.50 to 1.00%

Silicon (Si) may be an element which may be effective for deoxidation and solid solution strengthening and may accompany an increase of an impact transition temperature. To achieve target strength, a preferable content of Si may 0.50% or higher, but when a content of Si exceeds 1.00%, weldability may degrade, and impact toughness may be deteriorated.

Thus, in the present disclosure, it may be preferable to control a content of Si to be 0.50 to 1.00%. A more preferable content of Si may be 0.55 to 0.80%.

Mn: 0.3 to 0.8%

Manganese (Mn) may degrade a room temperature elongation rate and low temperature toughness by forming MnS, an elongated non-metal inclusion, along with sulfur (S). Thus, it may be preferable to control a content of Mn to be 0.8% or less. When a content of Mn is less than 0.3%, it may be difficult to secure strength of steel, which may be not preferable.

Thus, in the present disclosure, it may be preferable to control a content of Mn to be 0.3 to 0.8%. A more preferable content of Mn may be 0.5 to 0.7%.

Cr: 1.0 to 1.5%

Chromium (Cr) is an element which may increase high temperature strength, and to obtain a sufficient strength increasing effect, a preferable content of Cr may be 1.0% or higher. Cr is an expensive element, and when a content of Cr exceeds 1.5%, manufacturing costs may increase, which may not be preferable.

Thus, in the present disclosure, it may be preferable to control a content of Cr to be 1.0 to 1.5%. A more preferable content of Cr may be 1.2 to 1.4%.

Mo: 0.3 to 1.0%

Molybdenum (Mo) is an element which may be effective for improving high temperature strength similarly to Cr, and may prevent cracks caused by sulfides. To obtain the effect, a preferable content of Mo may be 0.3% or higher. However, as Mo is also an expensive element, when a content of Mo exceeds 1.0%, manufacturing costs may significantly increase.

Thus, in the present disclosure, it may be preferable to control a content of Mo to be 0.3 to 1.0%. A more preferable content of Mo may be 0.5 to 0.8%.

Ni: 0.003 to 0.30%

Nickel (Ni) is an element which may be effective for improving low temperature toughness. To this end, 0.003% or higher of Ni may need to be included. However, when a content of Ni exceeds 0.30%, the above-described effect may be saturated, and manufacturing costs may increase.

Thus, in the present disclosure, it may be preferable to control a content of Ni to be 0.003 to 0.30%. A more preferable content of Ni may be 0.05 to 0.25%.

Cu: 0.003 to 0.30%

Copper (Cu) is an element which may be effective for improving strength of steel, and the strength improving effect may be achieved by including 0.003% or higher of Cu. However, Cu is an expensive element, and when a content of Cu exceeds 0.30%, manufacturing costs may increase.

Thus, in the present disclosure, it may be preferable to control a content of Cu to be 0.003 to 0.30%. A more preferable content of Cu may be 0.05 to 0.20%.

Sol.Al: 0.005 to 0.06%

Sol.Al is a strong deoxidizer in the steelmaking process, similarly to Si. When a content of sol.Al is less than 0.005%, a deoxidation effect may be insignificant. When a content of sol.Al exceeds 0.06%, the deoxidation effect may be saturated and manufacturing costs may increase.

Thus, in the present disclosure, it may be preferable to control a content of sol.Al to be 0.005 to 0.06%.

P: 0.015% or less

Phosphorus (P) is an element which may degrade low temperature toughness and may increase temper embrittlement sensitivity. Thus, it may be preferable to control a content of P to be relatively low. However, a process for decreasing a content of P may be difficult, and manufacturing costs may increase due to an additional process. Thus, it may be preferable to control a content of P to be 0.015% or less.

S: 0.020% or less

Sulfur(S) is also an element which may decrease low temperature toughness, and may deteriorate toughness of steel by forming an MnS inclusion in steel. Thus, it may be preferable to control a content of S to be relatively low. However, a process for decreasing a content of S may be difficult, and manufacturing costs may increase due to an additional process. Thus, it may be preferable to control a content of S to be 0.020% or less.

Preferably, the steel for pressure vessels in the present disclosure may further include the elements described below to secure properties.

For example, the steel may include two or more selected from a group consisting of Nb, V, and Co.

Nb: 0.002 to 0.025%

Niobium (Nb) is an element which may be effective for preventing a matrix structure from softening by forming fine carbides or nitrides. To this end, a preferable content of Nb may be 0.002% or higher, but Nb is an expensive element, it may be preferable to control an upper limit content of Nb to be 0.025%.

V: 0.002 to 0.03%

Vanadium (V) may be an element which may easily form fine carbides or nitrides similarly to Nb. To this end, a preferable content of V may be 0.002% or higher, but V is an expensive element, it may be preferable to control an upper limit content of V to be 0.03%.

Co: 0.002 to 0.15%

Cobalt (Co) is an element which may have an effect of preventing a matrix structure from softening and delaying recovery of dislocation. A preferable content of Co may be within a range of 0.002 to 0.15%.

A remainder component of the present disclosure is iron (Fe). However, in a general manufacturing process, inevitable impurities from raw materials or a surrounding environment may be inevitably added, and thus, impurities may not be excluded. A person skilled in the art may be aware of the impurities, and thus, the descriptions of the impurities may not be particularly provided in the present disclosure.

The steel for pressure vessels having the above-described alloy composition in the present disclosure may have a microstructure configured as below.

More specifically, the steel for pressure vessels may include a mixture structure of tempered martensite and bainite, and a preferable area fraction of tempered martensite may be 20% or higher. When a phase faction of tempered martensite is less than 20%, strength may not be sufficiently secured, which may not be preferable. More preferably, a preferable area fraction of a tempered martensite phase may be 20 to 50%.

In the present disclosure, a bainite phase may include a tempered bainite phase.

The steel for pressure vessels in the present disclosure may include a fine MX-based carbide of 80 nm or less in a crystal grain of the microstructure, where M is Al, Nb, V, Cr, and Mo, and X is N and C.

As described above, the steel for pressure vessels in the present disclosure may have excellent PWHT resistance and appropriate strength and toughness by including fine carbides in a matrix structure.

Herein, the size may refer to an equivalent circular diameter of each of detected particles by observing a cross-sectional surface of the steel sheet taken in a thickness direction.

In the description below, a method of manufacturing steel for pressure vessels with excellent resistance with respect to a high-temperature tempering heat treatment and a post-weld heat treatment will be described.

The steel for pressure vessels in the present disclosure may be manufactured by performing processes of reheating, hot-rolling, heat treatment, cooling, and tempering to a steel slab satisfying the alloy composition suggested in the present disclosure. In the description below, process conditions of each process will be described in detail.

[Reheating Steel Slab]

It may be preferable to reheat a steel slab satisfying the above-described alloy composition at a temperature range of 1000 to 1250° C. When the reheating temperature is less than 1000° C., solid solution of solute atoms may be difficult. When the reheating temperature exceeds 1250° C., sizes of austenite crystal grains may excessively increase such that properties of the steel sheet may be deteriorated.

[Hot-Rolling]

It may be preferable to manufacture a hot-rolled steel sheet by hot-rolling the steel slab reheated as above. The hot-rolling may be performed under a reduction ratio of 5 to 30% for each pass.

When a reduction ratio for each pass during the hot-rolling is less than 5%, manufacturing costs may increase due to degradation of rolling productivity. When the reduction ratio for each pass exceeds 30%, load may be generated in a rolling mill, which may adversely affect a facility.

[Heat Treatment (Normalizing)]

It may be preferable to perform a heat treatment to the hot-rolled steel sheet manufactured as above at a certain temperature for a certain period of time. Specifically, it may be preferable to maintain the heat treatment at a temperature range of 850 to 950° C. for 1.3×t+10 to 30 minutes, where t indicates a thickness of the steel sheet in mm units.

When the temperature of the heat treatment is less than 850° C., it may be difficult to secure target strength as solid solution of solute atoms is difficult. When the temperature exceeds 950° C., growth of crystal grains may occur, which may deteriorate low temperature toughness.

When the maintaining time is less than 1.3×t+10 during the heat treatment performed at the above-described temperature range, homogenization of the structure may be difficult. When the maintaining time exceeds 1.3×t+30, productivity may degrade, which may not be preferable.

[Cooling]

It may be preferable to cool the hot-rolled steel sheet on which the heat treatment is performed to a room temperature at a cooling speed of 2 to 30° C./s.

When the cooling speed during the cooling is less than 2° C./s, coarse ferrite crystal grains may be created. When the cooling speed exceeds 30° C./s, excessive cooling facilities may be necessary, which may be not be preferable in an economical sense.

In the present disclosure, it may be preferable to perform the above-described heat treatment (normalizing) and cooling process three times.

Generally, a normalizing process is performed three times during the process of fitting steel for pressure vessels. In the process, there may be the problem of deterioration of strength and toughness of the steel. However, in the present disclosure, by performing the normalizing process three times in the process of manufacturing steel, the deterioration of strength and toughness may be significantly reduced after a PWHT process.

[Tempering]

It may be preferable to perform a tempering process in which the cooled hot-rolled steel sheet is maintained at a temperature range of 600 to 750° C. for 1.6×t+10 to 30 minutes, where t indicates a thickness of the steel sheet in mm units.

When the temperature is less than 600° C. during the tempering process, it may be difficult to secure target strength as it is difficult to precipitate a fine precipitate. When the temperature exceeds 750° C., growth of crystal grains may occur, which may deteriorate strength and low temperature toughness.

When the maintaining time is less than 1.6×t+10 minutes during the tempering process performed at the above-mentioned temperature range, homogenization of the structure may be difficult. When the maintaining time exceeds 1.6×t+30, productivity may be deteriorated.

It may be required to perform a PWHT treatment to the steel for pressure vessels manufactured by going through the above-described processes to remove residual stress by a welding process added when a pressure vessel is manufactured.

Generally, strength and toughness may degrade after a lengthy PWHT process. However, the steel for pressure vessels manufactured in the present disclosure may be able to be welded without significant degradation of strength and toughness even when a heat treatment is performed at a temperature range of 600° C. to (Ac1-20) ° C., a general PWHT temperature condition, for a long time (up to about 50 hours).

In particular, the steel sheet of the present disclosure may have 550 MPa or higher of tensile strength and 100 J or higher of a charpy impact energy value at −30° C. even after 50 hours of a PWHT process.

In the description below, an example embodiment of the present disclosure will be described in greater detail. It should be noted that the exemplary embodiments are provided to describe the present disclosure in greater detail, and to not limit the scope of rights of the present disclosure. The scope of rights of the present disclosure may be determined on the basis of the subject matters recited in the claims and the matters reasonably inferred from the subject matters.

### MODE FOR INVENTION

### Embodiment

A steel slab having the alloy composition as indicated in Table 1 below was prepared, and the steel slab was heated at 1140° C. for 300 minutes and was rolled under a reduction ratio of 5 to 20% per pass in a recrystallization region (1100−900° C.), thereby manufacturing a hot-rolled steel sheet. Thereafter, a heat treatment in which the hot-rolled steel sheet was maintained at a temperature range of 900 to 970° C. was performed, and was water-cooled to a room temperature at a cooling speed of 3.5 to 15° C./s with reference to a cooling speed of a central portion. A tempering process and a PWHT process were performed on the hot-rolled steel sheet under conditions indicated in Table 2 below.

A tension test was performed on the hot-rolled steel sheet for which the tempering process and the PWHT process were completed, and yield strength (YS), tensile strength (TS), and an elongation rate (El) were examined. Also, a charpy impact test was conducted and an impact energy value was examined at −30° C., and the results are listed in Table 3.

TABLE 1

| | Alloy Composition (wt %) | | | | | | | | | | | | |
|---|---|---|---|---|---|---|---|---|---|---|---|---|---|
| Steel | | | | | | Sol. | | | | | | | |
| Type | C | Mn | Si | P | S | Al | Ni | Cr | Mo | Cu | Nb | V | Co |
| A | 0.14 | 0.59 | 0.59 | 0.005 | 0.0011 | 0.028 | 0.13 | 1.35 | 0.60 | 0.10 | 0.018 | 0 | 0.15 |
| B | 0.13 | 0.55 | 0.62 | 0.006 | 0.0013 | 0.031 | 0.17 | 1.29 | 0.63 | 0.13 | 0 | 0.008 | 0.10 |
| C | 0.13 | 0.60 | 0.65 | 0.008 | 0.0015 | 0.030 | 0.14 | 1.30 | 0.65 | 0.12 | 0.020 | 0.010 | 0 |
| D | 0.14 | 0.56 | 0.58 | 0.008 | 0.0012 | 0.033 | 0.15 | 1.32 | 0.60 | 0.13 | 0 | 0 | 0 |

TABLE 2

| [symbol] | [symbol] | Manufacturing Conditions | | | | | | | [symbol] |
|---|---|---|---|---|---|---|---|---|---|
| | | Heat Treatment | Heat | Number of Heat | Tempering | | PWHT | PWHT | |
| | | Temperature | Treatment | Treatment | Temperature | Tempering | Temperature | Time | |
| | | (° C.) | Time (Min) | performed | (° C.) | Time (Min) | (° C.) | (hr) | |
| A | 50 | 910 | 85 | 3 | 730 | 100 | 710 | 15 | Inventive |
| | | | | | | | | | steel 1 |
| | 100 | 910 | 150 | 3 | 730 | 180 | 710 | 30 | Inventive |
| | | | | | | | | | steel 2 |
| | 150 | 910 | 210 | 3 | 730 | 260 | 710 | 50 | Inventive |
| | | | | | | | | | steel 3 |
| B | 50 | 910 | 85 | 3 | 730 | 100 | 710 | 15 | Inventive |
| | | | | | | | | | steel 4 |
| | 100 | 910 | 150 | 3 | 730 | 180 | 710 | 30 | Inventive |
| | | | | | | | | | steel 5 |
| | 150 | 910 | 210 | 3 | 730 | 260 | 710 | 50 | Inventive |
| | | | | | | | | | steel 6 |
| C | 50 | 910 | 85 | 3 | 730 | 100 | 710 | 15 | Inventive |
| | | | | | | | | | steel 7 |
| | 100 | 910 | 150 | 3 | 730 | 180 | 710 | 30 | Inventive |
| | | | | | | | | | steel 8 |
| | 150 | 910 | 210 | 3 | 730 | 260 | 710 | 50 | Inventive |
| | | | | | | | | | steel 9 |
| D | 50 | 910 | 85 | 3 | 730 | 100 | 710 | 15 | Comparative |
| | | | | | | | | | steel 1 |
| | 100 | 910 | 150 | 3 | 730 | 180 | 710 | 30 | Comparative |
| | | | | | | | | | steel 2 |
| | 150 | 910 | 210 | 3 | 730 | 260 | 710 | 50 | Comparative |
| | | | | | | | | | steel 3 |

[symbol]

indicates data missing or illegible when filed

TABLE 3

| | Microstructure | | Mechanical Properties | | | |
|---|---|---|---|---|---|---|
| | Tempered | Tempered | YS | TS | El | CVN @-30° C. |
| Classification | Martensite | Bainite | (MPa) | (MPa) | (%) | (J) |
| Inventive | 40 | 60 | 498 | 652 | 30 | 312 |
| steel 1 | | | | | | |
| Inventive | 30 | 70 | 482 | 642 | 31 | 323 |
| steel 2 | | | | | | |
| Inventive | 25 | 75 | 480 | 636 | 32 | 329 |
| steel 3 | | | | | | |
| Inventive | 42 | 58 | 487 | 645 | 32 | 319 |
| steel 4 | | | | | | |
| Inventive | 30 | 70 | 494 | 639 | 34 | 306 |
| steel 5 | | | | | | |
| Inventive | 27 | 73 | 507 | 627 | 33 | 318 |
| steel 6 | | | | | | |
| Inventive | 38 | 62 | 596 | 634 | 32 | 318 |
| steel 7 | | | | | | |
| Inventive | 30 | 70 | 582 | 628 | 33 | 326 |
| steel 8 | | | | | | |
| Inventive | 26 | 74 | 553 | 619 | 35 | 318 |
| steel 9 | | | | | | |
| Comparative | 15 | 85 | 401 | 521 | 30 | 275 |
| steel 1 | | | | | | |
| Comparative | 10 | 90 | 395 | 513 | 32 | 45 |
| steel 2 | | | | | | |
| Comparative | 7 | 93 | 394 | 509 | 33 | 38 |
| steel 3 | | | | | | |

As indicated in Tables 1 to 3, inventive steels 1 to 9 satisfying the alloy composition and the manufacturing conditions suggested in the present disclosure had 600 MPa or higher of tensile strength and 30% or higher of ductility even after a lengthy PWHT process (maximum of 50 hours), and had an excellent charpy impact energy value, 300J or higher.

Comparative steels 1 to 3 which did not satisfy the alloy composition of the present disclosure had lower strength than strength of the inventive steels after a PWHT process, and the longer the PWHT time, the greater the deterioration of low temperature toughness.

1. Steel for pressure vessels with excellent resistance with respect to a high-temperature tempering heat treatment and a post-weld heat treatment, the steel for pressure vessels comprising:
by wt %, 0.05 to 0.17% of C, 0.50 to 1.00% of Si, 0.3 to 0.8% of Mn, 1.0 to 1.5% of Cr, 0.3 to 1.0% of Mo, 0.003 to 0.30% of Ni, 0.003 to 0.30% of Cu, 0.005 to 0.06% of Sol.Al, 0.015% or less of P, 0.020% or less of S, two or more selected from a group consisting of 0.002 to 0.025% of Nb, 0.002 to 0.03% of V, and 0.002 to 0.15% of Co, and the balance of Fe and inevitable impurities,
wherein the steel comprises a mixture structure of tempered martensite and bainite as a microstructure, and an area fraction of tempered martensite is 20% or higher.

2. The steel for pressure vessels of claim 1, wherein the steel comprises 20 to 50% of tempered martensite phase in an area fraction.

3. The steel for pressure vessels of claim 1, wherein the steel comprises a fine MX-based carbide of 80 nm or less in a crystal grain of the microstructure, where M is Al, Nb, V, Cr, and Mo, and X is N and C.

4. The steel for pressure vessels of claim 1, wherein the steel has 550 MPa or higher of tensile strength even after a post-weld heat treatment, and has 100J or higher of a charpy impact energy value at −30° C.

5. A method of manufacturing steel for pressure vessels with excellent resistance with respect to a high-temperature tempering heat treatment and a post-weld heat treatment, comprising:
reheating a steel slab at 1000 to 1250° C., the steel slab comprising 0.05 to 0.17% of C, 0.50 to 1.00% of Si, 0.3 to 0.8% of Mn, 1.0 to 1.5% of Cr, 0.3 to 1.0% of Mo, 0.003 to 0.30% of Ni, 0.003 to 0.30% of Cu, 0.005 to 0.06% of Sol.Al, 0.015% or less of P, 0.020% or less of S, two or more selected from a group consisting of 0.002 to 0.025% of Nb, 0.002 to 0.03% of V, and 0.002 to 0.15% of Co, and the balance of Fe and inevitable impurities, by wt %,
manufacturing a hot-rolled steel sheet by hot-rolling the reheated steel slab;
performing a heat treatment in which the hot-rolled steel sheet is maintained at 850 to 950° C. for 1.3×t+10 to 30 minutes, where t indicates a thickness of the steel sheet in mm units;
cooling the hot-rolled steel sheet on which the heat treatment is performed at a cooling speed of 2˜30° C./s; and
performing a tempering treatment process in which the cooled hot-rolled steel sheet at 600 to 750° C. for 1.6×t+10 to 30 minutes, where t indicates a thickness of the steel sheet in mm units,
wherein the tempering treatment is performed after the heat treatment and the cooling are further performed twice.

6. The method of claim 5, wherein the hot-rolling is performed under a reduction ratio of 5 to 30% per pass.

7. The method of claim 5, wherein a post-weld heat treatment (PWHT) process is additionally performed for a maximum of 50 hours after the tempering treatment.
